(19) United States
(12) Patent Application Publication
(10) Pub. No.: US 2026/0236190 A1
(43) Pub. Date: Aug. 13, 2026

(54) SYSTEMS AND METHODS FOR A MEMORY-COMMUNICATIONS CORE AND OPERATING THE SAME

(71) Applicant: Samsung Electronics Co., Ltd., Suwon-si (KR)

(72) Inventors: Zongwang Li, Dublin, CA (US); Yang Seok Ki, Palo Alto, CA (US); Rekha Pitchumani, Oak Hill, VA (US)

(21) Appl. No.: 19/284,549

(22) Filed: Jul. 29, 2025

Related U.S. Application Data
(60) Provisional application No. 63/757,201, filed on Feb. 11, 2025.

(51) Int. Cl. G06F 3/06

(52) U.S. Cl. CPC G06F 3/0659; G06F 3/0611; G06F 3/0679

(57) ABSTRACT

Provided are systems and methods for a memory-communications core and operating the same. An example method includes receiving, by a processing circuit, a first command associated with a first memory type; determining, by the processing circuit, a processing protocol for the first command; based on applying the processing protocol to the first command, generating, by the processing circuit, a second command for a memory controller associated with a second memory type different from the first memory type; sending, by the processing circuit, the second command to the memory controller; and performing, by the processing circuit, a task on a buffer of the processing circuit based on the processing protocol, wherein the buffer has a lower latency for performing the task than the second memory type.

### CROSS-REFERENCE TO RELATED APPLICATIONS

This application claims priority to, and benefit of, U.S. Provisional Application Serial No. 63/757,201, filed on Feb. 11, 2025, entitled “CUSTOMIZED LOW-POWER DOUBLE DATA RATE (LPDDR) CORE FOR HIGH BANDWIDTH NAND CONTROLLER,” the entire content of which is incorporated herein by reference.

### FIELD

One or more aspects of embodiments according to the present disclosure relate to computing systems, and more particularly to systems and methods associated with memory communications.

### BACKGROUND

In the field of computers, a computing system may include one or more hosts and one or more memory devices connected to (e.g., communicatively coupled to) the one or more hosts. Such computing systems have become increasingly popular, in part, for allowing many different users to share the computing resources of the system. Memory requirements have increased over time as the number of users of such systems and the number and complexity of applications running on such systems have increased.

The present background section is intended to provide context only, and the disclosure of any embodiment or concept in this section does not constitute an admission that said embodiment or concept is prior art.

### SUMMARY

Aspects of some embodiments of the present disclosure are directed to computing systems for improved data access management.

According to some embodiments of the present disclosure, there is provided a method for a memory-communications core and operating the same. the method including: receiving, by a processing circuit, a first command associated with a first memory type, determining, by the processing circuit, a processing protocol for the first command, based on applying the processing protocol to the first command, generating, by the processing circuit, a second command for a memory controller associated with a second memory type different from the first memory type, sending, by the processing circuit, the second command to the memory controller, and performing, by the processing circuit, a task on a buffer of the processing circuit based on the processing protocol, wherein the buffer has a lower latency for performing the task than the second memory type.

In some embodiments, the method further includes determining, by the processing circuit, a command type of the first command, wherein the processing protocol is determined based on the command type.

In some embodiments, the command type is one of a row activation command, a row precharge command, a read command, or a write command.

In some embodiments, the first memory type is a dynamic random-access memory (DRAM) memory type, and the second memory type is a high bandwidth flash (HBF) NAND memory type.

In some embodiments, the first command is associated with a low-power double data rate (LPDDR) controller, and the memory controller is a high bandwidth flash (HBF) controller.

In some embodiments, the first command is an ac4tivation command, and performing the task includes writing data received from the memory controller to the buffer.

In some embodiments, the first command is a precharge command, and performing the task includes sending data from the buffer to the memory controller.

In some embodiments, the first command is a write command, and performing the task includes writing data associated with the first command to the buffer.

In some embodiments, the first command is a read command, and performing the task includes reading data from the buffer and sending the data from the processing circuit via a host interface coupled to the processing circuit.

According to some other embodiments of the present disclosure, there is provided a system for a memory-communications core and operating the same, the system including a processing circuit, and a memory storing instructions, which, based on being executed by the processing circuit, cause the processing circuit to perform: receiving, by a processing circuit, a first command associated with a first memory type, determining, by the processing circuit, a processing protocol for the first command, based on applying the processing protocol to the first command, generating, by the processing circuit, a second command for a memory controller associated with a second memory type different from the first memory type, sending, by the processing circuit, the second command to the memory controller, and performing, by the processing circuit, a task on a buffer of the processing circuit based on the processing protocol, wherein the buffer has a lower latency for performing the task than the second memory type.

In some embodiments, the instructions, based on being executed by the processing circuit, further cause the processing circuit to perform: determining a command type of the first command, wherein the processing protocol is determined based on the command type.

In some embodiments, the command type is one of a row activation command, a row precharge command, a read command, or a write command.

In some embodiments, the first memory type is a dynamic random-access memory (DRAM) memory type, and the second memory type is a high bandwidth flash (HBF) NAND memory type.

In some embodiments, the first command is associated with a low-power double data rate (LPDDR) controller, and the memory controller is a high bandwidth flash (HBF) controller.

In some embodiments, the first command is an activation command, and performing the task includes writing data received from the memory controller to the buffer.

In some embodiments, the first command is a precharge command, and performing the task includes sending data from the buffer to the memory controller.

In some embodiments, the first command is a write command, and performing the task includes writing data associated with the first command to the buffer.

In some embodiments, the first command is a read command, and performing the task includes reading data from the buffer and sending the data from the processing circuit via a host interface coupled to the processing circuit.

According to some other embodiments of the present disclosure, there is provided a system for a memory-communications core and operating the same, the system including a processing circuit, and a memory storing instructions, which, based on being executed by the processing circuit, cause the processing circuit to perform: receiving a first command, determining a processing protocol for the first command, based on applying the processing protocol to the first command, generating a second command for the memory controller, the memory controller associated with a memory type, sending the second command to the memory controller, and performing a task on the buffer based on the processing protocol, wherein the buffer has a lower latency than the memory type.

In some embodiments, the memory type is a NAND memory type.

### BRIEF DESCRIPTION OF THE DRAWINGS

Non-limiting and non-exhaustive embodiments of the present disclosure are described with reference to the following figures, wherein like reference numerals refer to like parts throughout the various views unless otherwise specified.

FIG. 1 is a block diagram depicting a system with a host device and a memory device, according to some embodiments of the present disclosure.

FIG. 2 is a block diagram depicting a front-end interface of the memory device and a memory controller of the host device, according to some embodiments of the present disclosure.

FIG. 3 is a block diagram depicting a memory-communications core of the front-end interface of the memory device, according to some embodiments of the present disclosure.

FIG. 4 is a block diagram depicting one or more operations of the memory-communications core, according to some embodiments of the present disclosure.

FIG. 5 is a diagram depicting a method for interfacing with a host device, according to some embodiments of the present disclosure.

FIG. 6 is a diagram depicting a method for reading data from a first memory controller (e.g., a memory controller of the memory device) to a second memory controller (e.g., the memory controller of the host device), according to some embodiments of the present disclosure.

FIG. 7 is a diagram depicting a method for writing data from the second memory controller to the first memory controller, according to some embodiments of the present disclosure.

Corresponding reference characters indicate corresponding components throughout the several views of the drawings. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

### DETAILED DESCRIPTION

Aspects of the present disclosure and methods of accomplishing the same may be understood more readily by reference to the detailed description of one or more embodiments and the accompanying drawings. Hereinafter, embodiments will be described in more detail with reference to the accompanying drawings. The described embodiments, however, may be embodied in various different forms, and should not be construed as being limited to only the illustrated embodiments herein. Rather, these embodiments are provided as examples so that this disclosure will be thorough and complete, and will fully convey aspects of the present disclosure to those skilled in the art. Accordingly, description of processes, elements, and techniques that are not necessary to those having ordinary skill in the art for a complete understanding of the aspects and features of the present disclosure may be omitted.

Unless otherwise noted, like reference numerals, characters, or combinations thereof denote like elements throughout the attached drawings and the written description, and thus, descriptions thereof will not be repeated. Skilled artisans will appreciate that elements in the figures are illustrated for simplicity and clarity, and have not necessarily been drawn to scale. For example, the dimensions of some of the elements, layers, and regions in the figures may be exaggerated relative to other elements, layers, and regions to help to improve clarity and understanding of various embodiments. Also, common but well-understood elements and parts not related to the description of the embodiments might not be shown to facilitate a less obstructed view of these various embodiments and to make the description clear.

In the detailed description, for the purposes of explanation, numerous specific details are set forth to provide a thorough understanding of various embodiments. It is apparent, however, that various embodiments may be practiced without these specific details or with one or more equivalent arrangements.

It will be understood that, although the terms “zeroth,” “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

It will be understood that when an element or component is referred to as being “on,” “connected to,” or “coupled to” another element or component, it can be directly on, connected to, or coupled to the other element or component, or one or more intervening elements or components may be present. However, “directly connected/directly coupled” refers to one component directly connecting or coupling another component without an intermediate component. Meanwhile, other expressions describing relationships between components such as “between,” “immediately between” or “adjacent to” and “directly adjacent to” may be construed similarly. In addition, it will also be understood that when an element or component is referred to as being “between” two elements or components, it can be the only element or component between the two elements or components, or one or more intervening elements or components may also be present.

The terminology used herein is for the purpose of describing particular embodiments only and is not intended to be limiting of the present disclosure. As used herein, the singular forms “a” and “an” are intended to include the plural forms as well, unless the context clearly indicates otherwise. It will be further understood that the terms “comprises,” “comprising,” “have,” “having,” “includes,” and “including,” when used in this specification, specify the presence of the stated features, integers, steps, operations, elements, and/or components, but do not preclude the presence or addition of one or more other features, integers, steps, operations, elements, components, and/or groups thereof. As used herein, each of the terms “or” and “and/or” includes any and all combinations of one or more of the associated listed items. For example, the expression "A and/or B" denotes A, B, or A and B.

For the purposes of this disclosure, expressions such as “at least one of,” when preceding a list of elements, modify the entire list of elements and do not modify the individual elements of the list. For example, “at least one of X, Y, or Z,” “at least one of X, Y, and Z,” and “at least one selected from the group consisting of X, Y, and Z” may be construed as X only, Y only, Z only, or any combination of two or more of X, Y, and Z, such as, for instance, XYZ, XYY, YZ, and ZZ.

As used herein, the term “substantially,” “about,” “approximately,” and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ± 30%, 20%, 10%, 5% of the stated value. Further, the use of “may” when describing embodiments of the present disclosure refers to “one or more embodiments of the present disclosure.”

When one or more embodiments may be implemented differently, a specific process order may be performed differently from the described order. For example, two consecutively described processes may be performed substantially at the same time or performed in an order opposite to the described order.

Any of the components or any combination of the components described (e.g., in any system diagrams included herein) may be used to perform one or more of the operations of any flow chart included herein. Further, (i) the operations are merely examples, and may involve various additional operations not explicitly covered, and (ii) the temporal order of the operations may be varied.

The electronic or electric devices and/or any other relevant devices or components according to embodiments of the present disclosure described herein may be implemented utilizing any suitable hardware, firmware (e.g. an application-specific integrated circuit), software, or a combination of software, firmware, and hardware. For example, the various components of these devices may be formed on one integrated circuit (IC) chip or on separate IC chips. Further, the various components of these devices may be implemented on a flexible printed circuit film, a tape carrier package (TCP), a printed circuit board (PCB), or formed on one substrate.

Further, the various components of these devices may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random-access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the spirit and scope of the embodiments of the present disclosure.

Any of the functionalities described herein, including any of the functionalities that may be implemented with a host, a device, and/or the like or a combination thereof, may be implemented with hardware, software, firmware, or any combination thereof including, for example, hardware and/or software combinational logic, sequential logic, timers, counters, registers, state machines, volatile memories such as dynamic RAM (DRAM) and/or static RAM (SRAM), nonvolatile memory including flash memory, persistent memory such as cross-gridded nonvolatile memory, memory with bulk resistance change, phase change memory (PCM), and/or the like and/or any combination thereof, complex programmable logic devices (CPLDs), field programmable gate arrays (FPGAs), application-specific ICs (ASICs), central processing units (CPUs) including complex instruction set computer (CISC) processors and/or reduced instruction set computer (RISC) processors, graphics processing units (GPUs), neural processing units (NPUs), tensor processing units (TPUs), data processing units (DPUs), and/or the like, executing instructions stored in any type of memory. In some embodiments, one or more components may be implemented as a system-on-a- chip (SoC).

Any of the computational devices disclosed herein may be implemented in any form factor, such as 3.5 inch, 2.5 inch, 1.8 inch, M.2, Enterprise and Data Center Standard Form Factor (EDSFF), NF1, and/or the like, using any connector configuration such as Serial Advanced Technology Attachment (SATA), Small Computer System Interface (SCSI), Serial Attached SCSI (SAS), U.2, and/or the like. Any of the computational devices disclosed herein may be implemented entirely or partially with, and/or used in connection with, a server chassis, server rack, data room, data center, edge data center, mobile edge data center, and/or any combinations thereof.

Any of the devices disclosed herein that may be implemented as storage devices may be implemented with any type of nonvolatile storage media based on solid-state media, magnetic media, optical media, and/or the like. For example, in some embodiments, a storage device (e.g., a computational storage device) may be implemented as an SSD based on not-AND (NAND) flash memory, persistent memory such as cross-gridded nonvolatile memory, memory with bulk resistance change, PCM, and/or the like, or any combination thereof.

Any of the communication connections and/or communication interfaces disclosed herein may be implemented with one or more interconnects, one or more networks, a network of networks (e.g., the Internet), and/or the like, or a combination thereof, using any type of interface and/or protocol. Examples include Peripheral Component Interconnect Express (PCIe), non-volatile memory express (NVMe), NVMe-over-fabric (NVMe-oF), Ethernet, Transmission Control Protocol/Internet Protocol (TCP/IP), Direct Memory Access (DMA) Remote DMA (RDMA), RDMA over Converged Ethernet (ROCE), FibreChannel, InfiniBand, SATA, SCSI, SAS, Internet Wide Area RDMA Protocol (iWARP), and/or a coherent protocol, such as Compute Express Link (CXL), CXL.mem, CXL.cache, CXL.IO and/or the like, Gen-Z, Open Coherent Accelerator Processor Interface (OpenCAPI), Cache Coherent Interconnect for Accelerators (CCIX), and/or the like, Advanced eXtensible Interface (AXI), any generation of wireless network including 2G, 3G, 4G, 5G, 6G, and/or the like, any generation of Wi-Fi, Bluetooth, near-field communication (NFC), and/or the like, or any combination thereof.

In some embodiments, a software stack may include a communication layer that may implement one or more communication interfaces, protocols, and/or the like such as PCIe, NVMe, CXL, Ethernet, NVMe-oF, TCP/IP, and/or the like, to enable a host and/or an application running on the host to communicate with a computational device or a storage device.

Each of the terms “processing circuit” and “means for processing” is used herein to mean any suitable combination of hardware, firmware, and software, employed to process data or digital signals. Processing circuit hardware may include, for example, application specific integrated circuits (ASICs), general purpose or special purpose central processing units (CPUs), digital signal processors (DSPs), graphics processing units (GPUs), and programmable logic devices such as field programmable gate arrays (FPGAs). In a processing circuit, as used herein, each function is performed either by hardware configured, i.e., hard-wired, to perform that function, or by more general-purpose hardware, such as a CPU, configured to execute instructions stored in a non-transitory storage medium. A processing circuit may be fabricated on a single printed circuit board (PCB) or distributed over several interconnected PCBs. A processing circuit may contain other processing circuits; for example, a processing circuit may include two processing circuits, an FPGA and a CPU, interconnected on a PCB.

Unless otherwise defined, all terms (including technical and scientific terms) used herein have the same meaning as commonly understood by one of ordinary skill in the art to which the present inventive concept belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

As mentioned above, in the field of computers, a computing system may include one or more hosts and one or more memory devices, such as storage devices, connected to (e.g., communicatively coupled to) the one or more hosts. Many mobile platforms utilize a low-power double data rate (LPDDR) dynamic random-access memory (DRAM) system for high throughput applications, which includes an LPDDR memory controller at a host device that interfaces with a DRAM device. The LPDDR memory controller may be a memory controller that is used to communicate with a memory type (e.g., DRAM) having lower latencies than other memory types (e.g., NAND flash memory).

High Bandwidth NAND (HBN) is a type of NAND flash memory with a wide input/output (I/O) interface, which provides more data channels (e.g., I/O lines) for faster communication with the memory controller and higher throughput. Due to its high bandwidth and throughput, High Bandwidth NAND (HBN) memory may be able to improve the performance of devices (e.g., mobile devices) for high throughput applications like large language model (LLM) applications and other artificial intelligence (AI) or machine learning (ML) applications, among others. A high-bandwidth flash (HBF) controller may be a memory controller that is used to communicate with HBN. HBN may have higher latencies than some other memory types (e.g., DRAM).

It may be advantageous to utilize HBN memory with LPDDR memory controllers to reap the benefits of HBN memory without having to make significant changes (e.g., without having to make any changes) to the host device. However, HBN memory is generally incompatible with conventional LPDDR memory controllers. LPDDR memory controllers conventionally operate with DRAM (e.g., LPDDR memory controllers may be used to communicate with DRAM), and may operate on DRAM-specific latency times, command protocols, and addressing protocols. HBN memory may have higher latency times than DRAM, as well as different command and addressing protocols. Due to the difference in latency between DRAM and HBN memory, there may be a timing incompatibility that may cause system issues or errors if an LPDDR memory controller were to attempt to read data from, or write data to, an HBN directly. Additionally, HBN memory may respond to different command inputs and addressing inputs than those issued by LPDDR memory controllers.

The present disclosure provides systems and methods that enable a memory device that utilizes HBN memory to be compatible with a host device that utilizes LPDDR memory controllers. The memory device may include a processing circuit referred to herein as a memory-communications core or an LPDDR core. The LPDDR core may facilitate interactions between the LPDDR memory controller and an HBF memory controller of the memory device. In some embodiments, the LPDDR core receives a command from the LPDDR memory controller that is intended for a DRAM device. The LPDDR core may determine the command type and process the command using a processing protocol for the specific command type. For example, the types of commands may include an activation command for activating a row of a DRAM, a precharge command for closing or a row of a DRAM, a read command to read data from the DRAM or DRAM row buffer, or a write command to write data to the DRAM or DRAM row buffer. In some embodiments, the types of commands may also include calibration commands for initializing communication between the host device and the memory device. In some embodiments, the types of commands may also include miscellaneous commands that are disregarded by the LPDDR core and no action is taken with respect to the HBF memory controller. The LPDDR core may issue a new command for the HBF controller based on applying a corresponding processing protocol to the command received from the LPDDR memory controller. The LPDDR core thereby transforms (e.g., translates or changes) the LPDDR command intended for a DRAM into a new command that is compatible with the HBF memory controller.

In some embodiments, the LPDDR core includes a page buffer, and the LPDDR core performs a task on the buffer such as a read or write operation based on the command received from the LPDDR memory controller. In some embodiments, the page buffer facilitates the passing of data between the LPDDR memory controller and the HBF controller. For example, the LPDDR core may receive data from the HBF controller and store (e.g., “write”) the data to the page buffer, and send (e.g., “read”) the data from the page buffer to the LPDDR memory controller. The LPDDR core may also receive data from the LPDDR memory controller and store the data in the page buffer, and may send the data from the page buffer to the HBF memory controller. In some embodiments, the page buffer includes a memory (e.g., a static random-access memory (SRAM) or DRAM), which has a latency that is operable (e.g., that is compatible) with the LPDDR memory controller. Thus, the LPDDR memory controller can read data from the buffer and write data to the buffer without timing issues. The present techniques may allow HBN to be used in devices (e.g., mobile devices) with LPDDR memory controllers without changes (e.g., without significant changes) to the memory controller (e.g., the application-processor memory controller) of the host device.

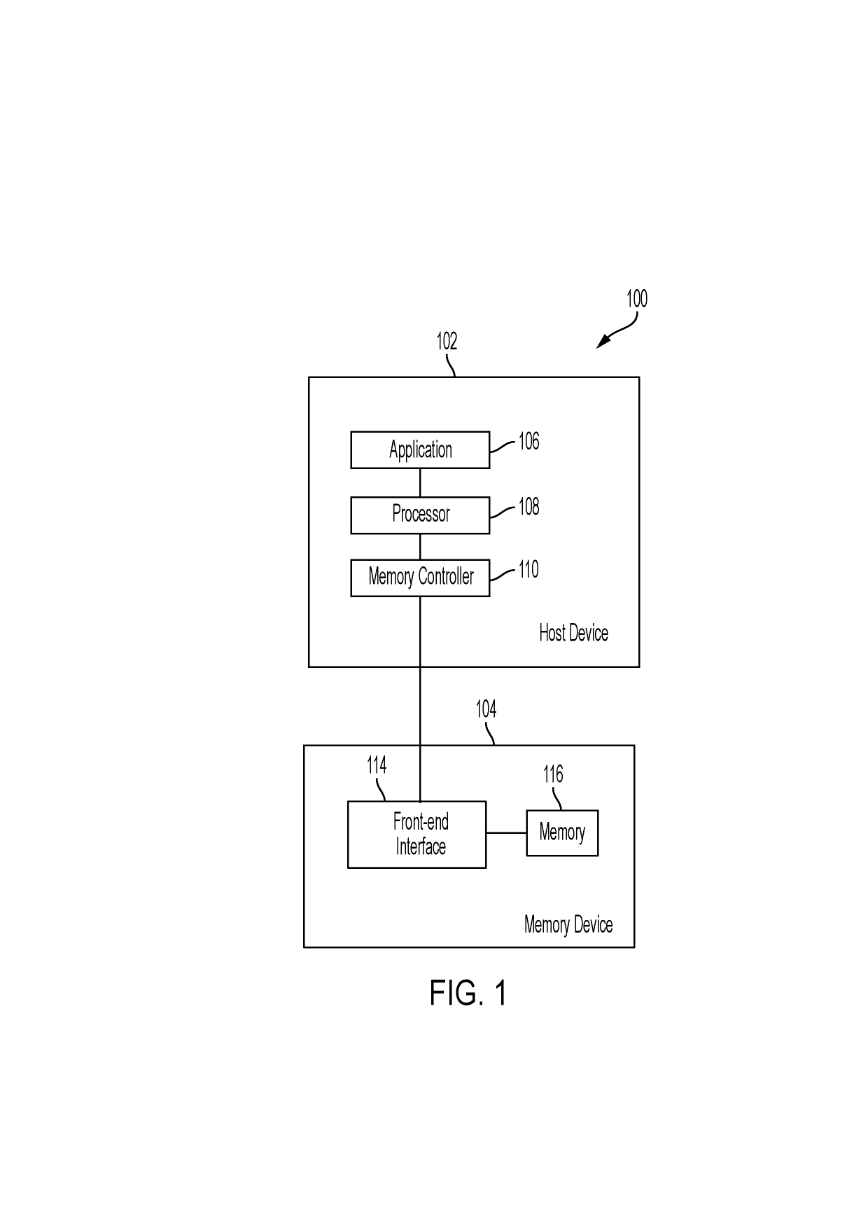

FIG. 1 is a block diagram depicting a system 100 with a host device 102 (e.g., a host computing device) and a memory device 104, according to some embodiments of the present disclosure. Referring to FIG. 1, the system 100 may include the host device 102 and the memory device 104. In some embodiments, the host device 102 and the memory device 104 may communicate via data communication links or general-purpose interfaces such as, for example, an LPDDR interface, Ethernet, Universal Serial Bus (USB), and/or any wired or wireless data communication link.

The host device 102 may include a processor 108, an application 106, and a memory controller 110. The processor 108 may include one or more central processing unit (CPU) cores configured to run one or more applications 106 based on computer program instructions stored in a system memory, elsewhere in the host device 102, in the memory device 104, elsewhere in the system 100, or obtained via one or more communication links.

The processor 108 may be or may include a processing circuit and may include, for example, a digital circuit (e.g., a microcontroller, a microprocessor, a digital signal processor, or a logic device (e.g., a field programmable gate array (FPGA), an application-specific integrated circuit (ASIC), and/or the like) capable of executing data access instructions (e.g., via firmware and/or software) to provide access to and from the data stored in the memory device 104 according to the data access instructions.

The application 106 may be any application configured to transmit requests (e.g., write and/or read requests) for the memory controller 110 to access the memory device 104. For example, the application 106 may be a big data analysis application, large language model application, e-commerce application, database application, artificial intelligence application, machine learning application, and/or the like.

The memory controller 110 may be configured to facilitate interactions between the processor 108 and a memory such as memory device 104. For example, the memory controller 110 may execute read and write (or load and store) commands with respect to the memory device 104. In some embodiments, the memory controller 110 is an LPDDR memory controller configured to interface with an LPDDR DRAM. In some embodiments, the memory controller 110 may access multiple memory devices, including the memory device 104. For example, the multiple memory devices may have respective Ranks, where each Rank refers to a group of memory chips that can be accessed simultaneously by the memory controller. For example, the memory device 104 may be a Rank 1 memory device and may be enabled by a chip select for Rank 1.

The memory device 104 may include a memory 116 and a front-end interface 114. The front-end interface 114 may be connected to the memory 116 over one or more storage interfaces such as Serial Advanced Technology Attachment, Non-Volatile Memory Express, Peripheral Component Interconnect Express, Serial Attached SCSI, M.2 Form Factor, Direct Memory Access, and/or the like. The front-end interface 114 may receive requests from the memory controller 110 and facilitate interactions between the memory controller 110 and memory 116 (e.g., HBN memory). In some embodiments, such as in embodiments in which the memory controller 110 is an LPDDR memory controller, the memory 116 may exhibit a higher latency time than a latency time that is compatible with the LPDDR memory controller. In such cases, the front-end interface may be configured to control aspects of the memory device 104 such that the memory controller 110 experiences the expected latency time for read and write operations.

In some embodiments, the host device 102 may include one or more kernels. In some embodiments, a device driver may be installed in a kernel. The device driver may enable the memory controller 110 to interact (e.g. execute read/write requests) with the front-end interface 114 of the memory device 104. In some embodiments, the application 106 includes or utilizes a library and/or an application programming interface (API) that facilitates requests to be made to the device driver and to the memory device 104.

In some embodiments, some connections between various components illustrated in FIG. 1 enable the components to send and receive data using a protocol such as, for example, a Compute Express Link (CXL), although embodiments are not limited thereto. In addition or in lieu of CXL, various interfaces may use other protocols such as Cache Coherent Interconnect for Accelerators (CCIX), dual in-line memory module (DIMM) interface, Small Computer System Interface (SCSI), Non Volatile Memory Express (NVMe), Peripheral Component Interconnect Express (PCIe), remote direct memory access (RDMA) over Ethernet, Serial Advanced Technology Attachment (SATA), Fiber Channel, Serial Attached SCSI (SAS), NVMe over Fabric (NVMe-oF), iWARP protocol, InfiniBand protocol, 5G wireless protocol, Wi-Fi protocol, Bluetooth protocol, and/or the like.

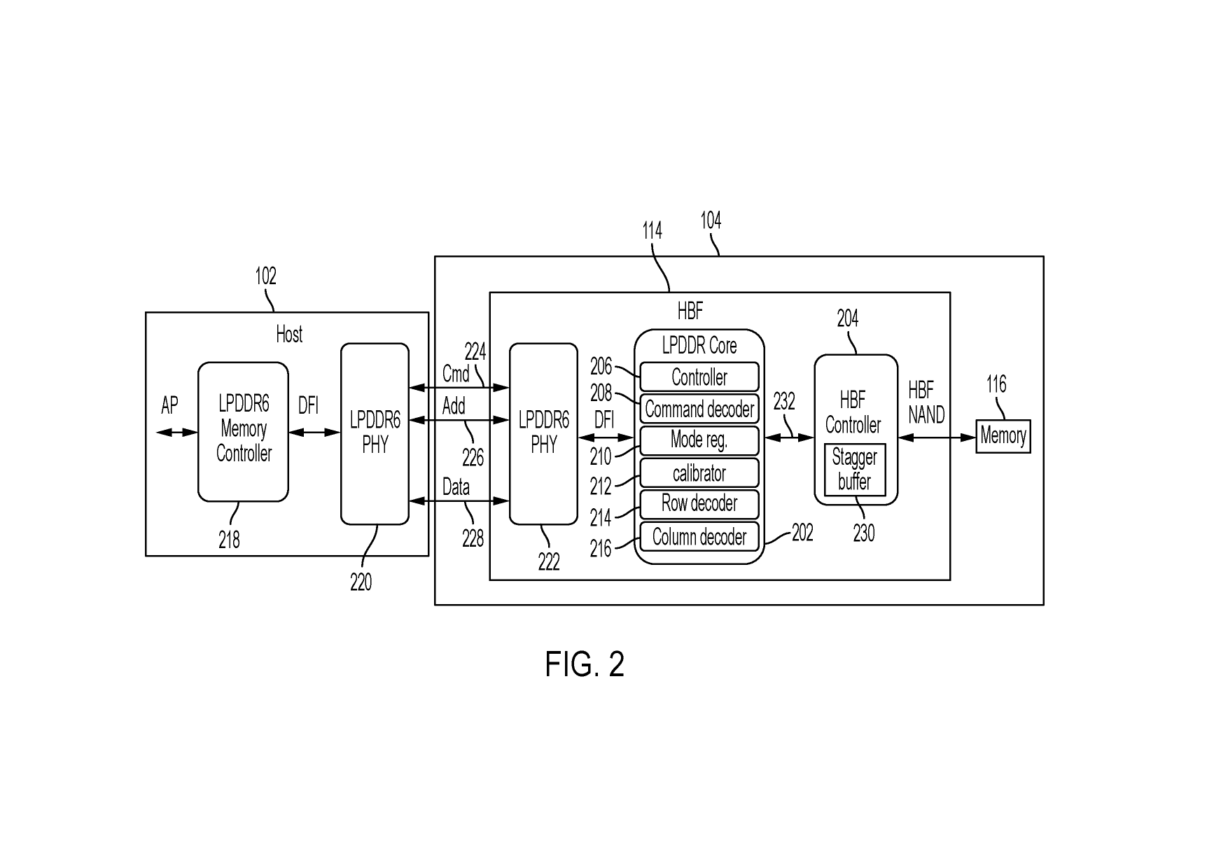

FIG. 2 is a block diagram depicting the front-end interface 114 of the memory device 104 and the memory controller 110 of the host device 102, according to some embodiments of the present disclosure. Referring to FIG. 2, the host device 102 may include an LPDDR memory controller 218 and an LPDDR physical layer 220 (e.g., an LPDDR6 physical layer). The LPDDR memory controller may correspond to the memory controller 110 of FIG. 1. In some embodiments, the front-end interface 114 may include a host interface such as an LPDDR physical layer 222 (e.g., an LPDDR6 physical layer), one or more processing circuits and/or components collectively referred to as an LPDDR core 202, and an HBF memory controller 204.

The LPDDR physical layer 222 of the memory device 104 may be connected to (e.g., communicatively coupled to, or communicably coupled to) the LPDDR physical layer 220 of the host device 102 to transmit signals from the LPDDR memory controller 218 to the LPDDR core 202. In some embodiments, LPDDR physical layers 220, 222 include a command bus 224, an address bus 226, and data bus 228. In some embodiments, the LPDDR physical layers 220, 222 may include standard components and configurations according to LPDDR specifications.

The LPDDR core 202 may include one or more processing circuits and/or components that make up modules including a controller 206 (e.g., a data controller), a command decoder 208, a mode register 210, a calibrator 212, a row decoder, and a column decoder 216. In some embodiments, the LPDDR core 202 may receive information from the LPDDR memory controller 218 via the LPDDR physical layers 220, 222 that is intended for (e.g., configured for) a DRAM device. The information may include one or more of a command, an address, and/or data (e.g., data associated with an application 106). In some embodiments, the command signal is received via the command bus 224 of the LPDDR physical layer 222, the address signal is received via the address bus 226 of the LPDDR physical layer 222, and the data signal is received via the data bus 228 of the LPDDR physical layer 222. In some embodiments, the LPDDR core 202 processes the information received from the LPDDR memory controller 218 to generate commands for the HBF controller for interacting with the memory 116 (e.g., HBN memory).

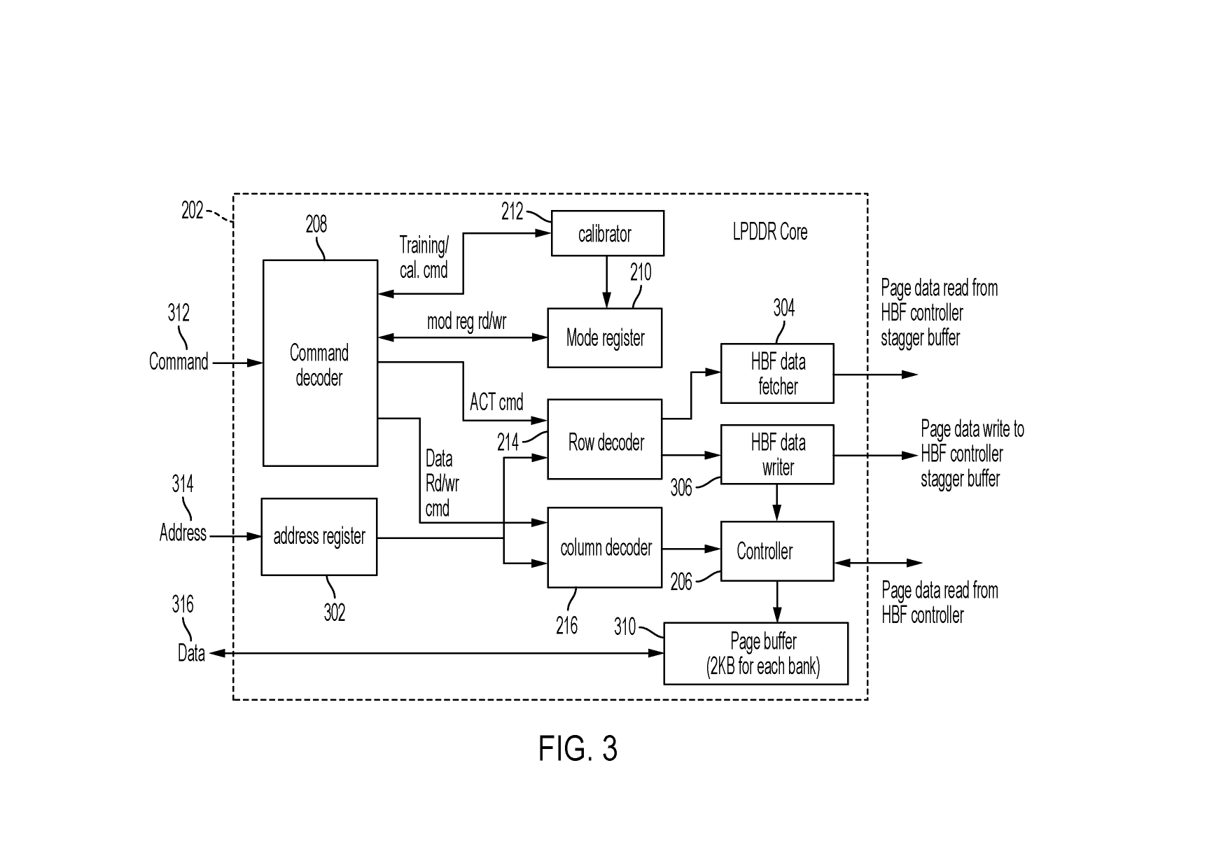

FIG. 3 is a block diagram depicting a memory-communications core (e.g., LPDDR core 202) of the front-end interface 114 of the memory device 104, according to some embodiments of the present disclosure. In some embodiments, in addition to the controller 206, command decoder 208, mode register 210, calibrator 212, row decoder 214, and column decoder 216 depicted in FIG. 2, the LPDDR core 202 also includes an address register 302, an HBF data fetcher 304, an HBF data writer 306, and a page buffer 310.

Referring to FIGS. 2 and 3, in some embodiments, the command decoder 208 receives a command 312 (e.g., an LPDDR command) issued by the LPDDR memory controller via the command bus 224 of the LPDDR physical layer 222. The command decoder 208 may determine a command type of the received command 312. In some embodiments, the command type may include (e.g., may be) an activation command, a precharge command, a write command, a read command, a calibration command, or a non-data command. The command decoder 208 may determine a processing protocol for handling the command 312 based on the command type.

For example, the LPDDR memory controller 218 may issue an activation command to activate (e.g., intended to activate or configured to activate) a row buffer of a DRAM and read data from a DRAM cell into the row buffer, which may be an operation (e.g., a step) that is performed to read data from DRAM or to write data to DRAM. In response to an activation command from the LPDDR memory controller 218, the LPDDR core 202 may fetch data associated with the activation command and may store the data in the page buffer 310, where it can be accessed when the LPDDR memory controller 218 issues a read command for the data or a portion of the data. In some embodiments, when the LPDDR core 202 receives an activation command, the command decoder 208 passes the command to the row decoder 214. In some embodiments, the address register 302 receives address information for the row to be activated via the address bus 226. The row decoder 214 may obtain the row address from the address register 302 and may issue a request with the row address to the HBF data fetcher 304. The HBF data fetcher 304 may fetch the data associated with the row address from the HBF memory controller 204 and may copy the data to the page buffer 310 via the controller 206. In some embodiments, the row address may correspond to a page of the memory 116 (e.g., the HBN memory).

In some embodiments, the LPDDR memory controller 218 may issue a read command intended to read data from an activated row of DRAM, such as data at a certain column of the activated row. The command decoder 208 may receive the read command and pass the read command to the column decoder 216. The address register 302 may receive the column address associated with the requested data of the read command. In some embodiments, the controller 206 controls the flow of data in the LPDDR core 202, including reading from the page buffer 310 and writing to the page buffer 310. The column decoder 216 may obtain the column address from the address register 302 and may send a request to the controller 206 to send the corresponding data from the page buffer 310 to the LPDDR memory controller 218 via the data bus 228, thus fulfilling the read command. For example, the data associated with the column address may have previously been fetched from the HBF memory controller 204 to the page buffer 310 via the controller 206 in response to an activation request. In some embodiments, the page buffer 310 includes a memory type (e.g., SRAM or DRAM) that has a latency that is compatible with the LPDDR memory controller. Thus, the LPDDR memory controller 218 can receive the requested data from the page buffer 310 in response to a read command in an expected amount of time (e.g., in an amount of time that is compatible with the operations of the LPDDR memory controller 218). Making the memory type of the page buffer 310 compatible with the operations of the LPDDR memory controller may allow the memory device 104 to meet the LPDDR timing specifications and avoid an error.

In some embodiments, the LPDDR memory controller 218 may issue a write command intended to write data to DRAM to a column of an activated row. The command decoder 208 may receive the write command and may pass the write command to the column decoder 216. The address register 302 may receive a column address associated with the write command. The LPDDR core 202 may also receive the data to be written via the data bus 228. The column decoder 216 may obtain the column address from the address register 302 and may send a request to the controller 206 to write the received data to the page buffer 310 at a location corresponding to the column address. In some embodiments, the page buffer 310 includes memory (e.g., SRAM or DRAM) that has a latency that is compatible with the LPDDR memory controller 218. Thus, the LPDDR memory controller 218 may write data to the page buffer 310 in response to a write command in an expected amount of time (e.g., in an amount of time that is compatible with the operations of the LPDDR memory controller 218). This allows the memory device 104 to meet the LPDDR timing specifications and avoid an error.

In some embodiments, the LPDDR memory controller 218 may issue a precharge command intended to close or deactivate a row of a DRAM. In response to a precharge command from the LPDDR memory controller 218, the LPDDR core 202 may send data from the page buffer 310 associated with the precharge command and to the HBF memory controller 204 via the controller 206, which stores the data to the memory 116 (e.g., the HBN memory). In some embodiments, when the LPDDR core 202 receives a precharge command, the command decoder 208 passes the command to the row decoder 214. In some embodiments, the address register 302 receives address information for the row to be closed by the precharge command via the address bus 226. The row decoder 214 may obtain the row address from the address register 302 and may issue a request with the row address to the HBF data writer 306. The HBF data writer 306 may send the data from the page buffer 310 to the HBF memory controller 204 via the controller 206. In some embodiments, the HBF data writer 306 writes data from the page buffer 310 to a buffer (e.g., a stagger buffer 230) of the HBF memory controller 204. In some embodiments, the buffer of the HBF memory controller 204 (e.g., stagger buffer 230) may be a larger buffer than the page buffer 310.

In some embodiments, the LPDDR memory controller 218 may issue a calibration command intended to calibrate a DRAM device so that signal timing, voltage levels, and data alignment are optimized for reliable communication between the LPDDR memory controller 218 and the memory device. When the command decoder 208 receives a calibration command, the command decoder 208 may pass (e.g., send) the command to the calibrator 212. The calibrator 212 may receive the calibration command. The calibration command may include input signal patterns from the LPDDR memory controller 218. The calibrator 212 may execute adjustments to tune (e.g., to fine tune) internal parameters like signal timing, impedance, or voltage levels based on the configured settings and real-time signal conditions. The mode register 210 may receive configuration values from the LPDDR memory controller 218 and status or control feedback from the calibrator 212, providing a configuration interface, enabling or defining specific calibration behaviors, such as timing alignment or voltage reference tuning. The calibrator 212 and mode register 210 may be accessed by the LPDDR memory controller 218 without latency issues. The calibration of communications between the LPDDR memory controller 218 and the HBF memory controller 204 may be resolved within the LPDDR core 202, such that the LPDDR core 202 operates in a manner similar to a DRAM. For example, the LPDDR core 202 may appear to the LPDDR memory controller 218 to have characteristics associated with a compatible memory (e.g., characteristics associated with a DRAM). Accordingly, the LPDDR memory controller 218 may not interact with the memory cells directly, and the latency of the memory device 104 may not cause errors for memory communications.

In some embodiments, the LPDDR memory controller 218 may issue LPDDR commands that are non-data commands or commands that have no corresponding action with respect to the HBF memory controller 204 or with respect to the memory 116 (e.g., the HBN memory). When the command decoder 208 receives such a command, the command decoder 208 may not execute any further action with respect to the command. For example, the command decoder 208 may treat such commands as dummy commands.

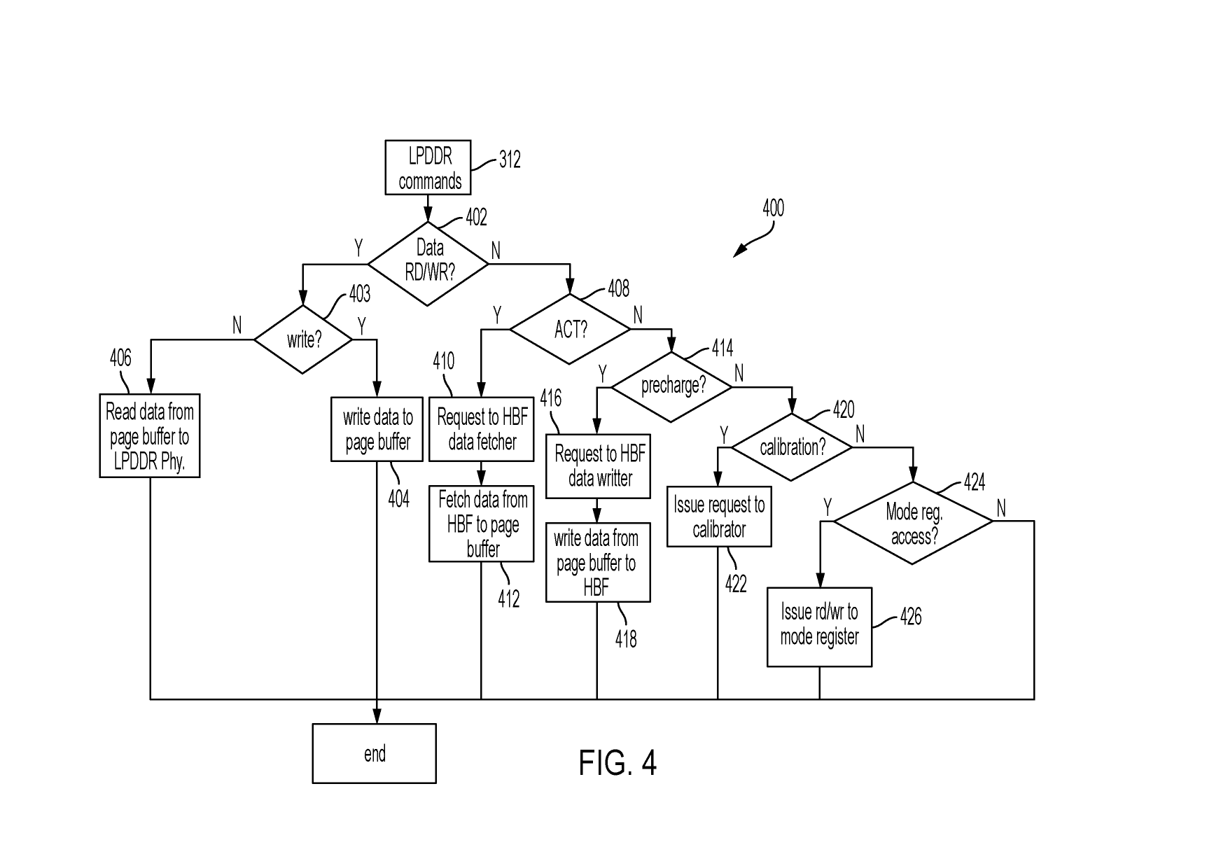

FIG. 4 is a block diagram depicting one or more operations of a memory-communications core (e.g., LPDDR core 202), according to some embodiments of the present disclosure. Although FIG. 4 illustrates various operations in a method for interfacing with a host device 102, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure. Referring to FIG. 4, the method 400 may include one or more of the following operations. The LPDDR core 202 may receive a command 312 (e.g., an LPDDR command), such as from the LPDDR memory controller 218. At operation 402, the LPDDR core 202 may determine if the command 312 is a data read or write command. If the command 312 is a data read or write command, at operation 403, the LPDDR core 202 may determine if the command 312 is a data write command. If the command 312 is a data write command, at operation 404, the LPDDR core 202 may write data received from the LPDDR memory controller 218 to the page buffer 310. If at operation 403, the LPDDR core 202 determines the command 312 is not a write command, then the LPDDR core 202 may determine that the command 312 is a read command. At operation 406, based on determining that the command 312 is a read command, the LPDDR core 202 may read data from the page buffer 310 to the LPDDR physical layer 222 for transmitting to the LPDDR memory controller 218. At operation 402, if the LPDDR core 202 determines the command 312 is not a data read/write command, at operation 408, the LPDDR core 202 may determine if the command 312 is an activation command (e.g., ACT) for activating a DRAM row.

If the LPDDR core 202 determines that the command 312 is an activation command, at operation 410, the LPDDR core 202 may issue (e.g., may send) a request to the HBF data fetcher 304 to read data from the HBF memory controller 204. In some embodiments, the HBF data fetcher 304 reads the data from a stagger buffer 230 of the HBF controller. At operation 412, the LPDDR core 202 may further fetch data from the HBF controller to the page buffer 310 via the controller 206.

At operation 408, if the LPDDR core 202 determines that the command 312 is not an activation command, at operation 414, the LPDDR core 202 may determine if the command 312 is a precharge command.

If the command 312 is a precharge command, at operation 416, the LPDDR core 202 may issue a request to the HBF data writer 306. At operation 418, the LPDDR core 202 may write data from the page buffer 310 to the HBF memory controller 204 via the controller 206. At operation 414, if the LPDDR core 202 determines that the command 312 is not a precharge command, at operation 420, the LPDDR core 202 may determine if the command 312 is a calibration command.

If the LPDDR core 202 determines that the command 312 is a calibration command, at operation 422, the LPDDR core 202 may issue a request to the calibrator 212. At operation 420, if the LPDDR core 202 determines that the command 312 is not a calibration command, at operation 424, the LPDDR core 202 may determine if the command 312 is a mode register access command. If the LPDDR core 202 determines that the command 312 is a mode register access command, the LPDDR core 202 may issue a read or write command to the mode register 210. If the LPDDR core 202 determines that the command 312 is not a mode register access command, the operation may end. In some embodiments, if the command 312 is not one of a read command, a write command, an activation command, a precharge command, a calibration command, or a mode registered access command, the LPDDR core 202 may disregard the command 312, and no further action may be taken in response to the command 312.

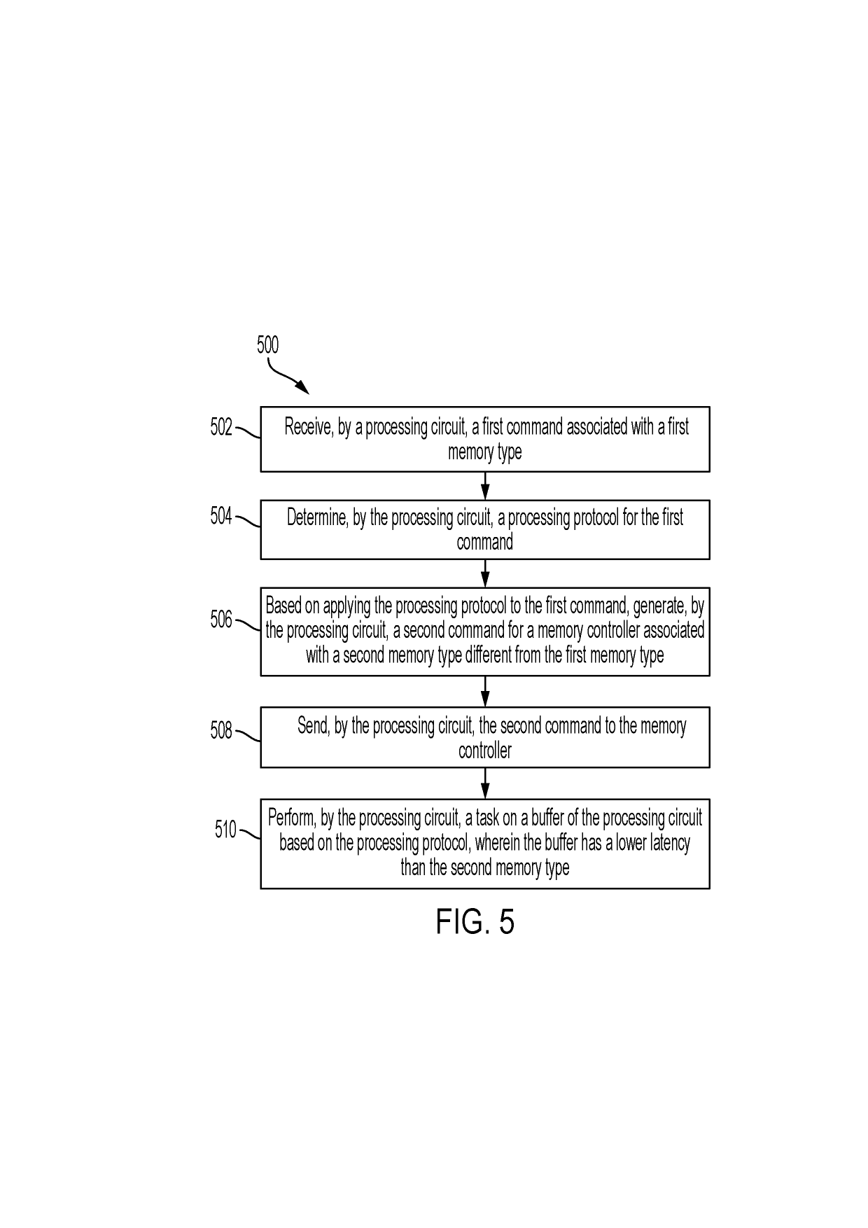

FIG. 5 is a diagram depicting a method for interfacing with a host device, according to some embodiments of the present disclosure. Referring to FIG. 5, the method 500 may include one or more of the following operations. Although FIG. 5 illustrates various operations in a method for interfacing with a host device 102, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure.

At operation 502, a processing circuit (e.g., LPDDR core 202) may receive a first command (e.g., command 312) associated with a first memory type. For example, the first memory type may be a DRAM memory type such as an SDRAM. In some embodiments, the first command is associated with an LPDDR memory controller 218. For example, as discussed above with reference to FIG. 2, the LPDDR core 202 may receive a command (e.g., command 312) associated with a first memory type (e.g., SDRAM) from the LPDDR memory controller 218, and generate instructions for the HBF memory controller 204 in order to carry out the command from the LPDDR memory controller 218.

At operation 504, the processing circuit (e.g., LPDDR core 202) determines a processing protocol for the first command (e.g., command 312). In some embodiments, the processing circuit (e.g., LPDDR core 202) determines a command type of the first command (e.g., command 312), and determines the processing protocol based on the command type. For example, the command type may be one of a row activation command, a row precharge command, a read command, or a write command. In some embodiments, the command may be an LPDDR command for controlling a memory device having a DRAM. For example, as discussed above with reference to FIG. 3, the command decoder 208 may determine the command type and pass the command 312 or a filtered version of the command 312 to the corresponding modules (e.g., calibrator 212, mode register, row decoder 214, column decoder 216) of the LPDDR core 202 based on the command type.

At operation 506, based on applying the processing protocol to the first command (e.g., command 312), the processing circuit (e.g., LPDDR core 202) generates a second command 232 for a memory controller (e.g., the HBF memory controller 204) associated with a second memory type different from the first memory type. For example, the second memory type may be a high bandwidth flash (HBF) NAND memory type.

At operation 508, the processing circuit (e.g., LPDDR core 202) sends the second command 232 to the memory controller (e.g., the HBF memory controller 204). In some embodiments, the memory controller is a HBF memory controller 204. In some embodiments, the HBF memory controller 204 controls a memory 116 (e.g., NAND).

At operation 510, the processing circuit (e.g., LPDDR core 202) performs a task on a buffer (e.g., page buffer 310) of the processing circuit (e.g., LPDDR core 202) based on the processing protocol for the first command. In some embodiments, the buffer (e.g., page buffer 310) has a lower latency than the second memory type. For example, the buffer (e.g., page buffer 310) may include or utilize DRAM or SRAM, which may have read/write latencies that are compatible with an LPDDR memory controller 218. In some embodiments, the first command (e.g., the command 312) is an activation command, and performing the task includes writing data received from the memory controller (e.g., the HBF memory controller 204) to the buffer (e.g., page buffer 310). In some embodiments, the first command (e.g., the command 312) is a precharge command, and performing the task includes sending data from the buffer (e.g., page buffer 310) to the memory controller (e.g., the HBF memory controller 204). In some embodiments, the first command (e.g., the command 312) is a write command, and performing the task includes writing data associated with the first command to the buffer (e.g., page buffer 310). In some embodiments, the first command (e.g., the command 312) is a read command, and performing the task includes reading data from the buffer (e.g., page buffer 310) and sending the data from the processing circuit (e.g., LPDDR core 202) via a host interface (e.g., LPDDR physical layer 222) coupled to the processing circuit (e.g., LPDDR core 202).

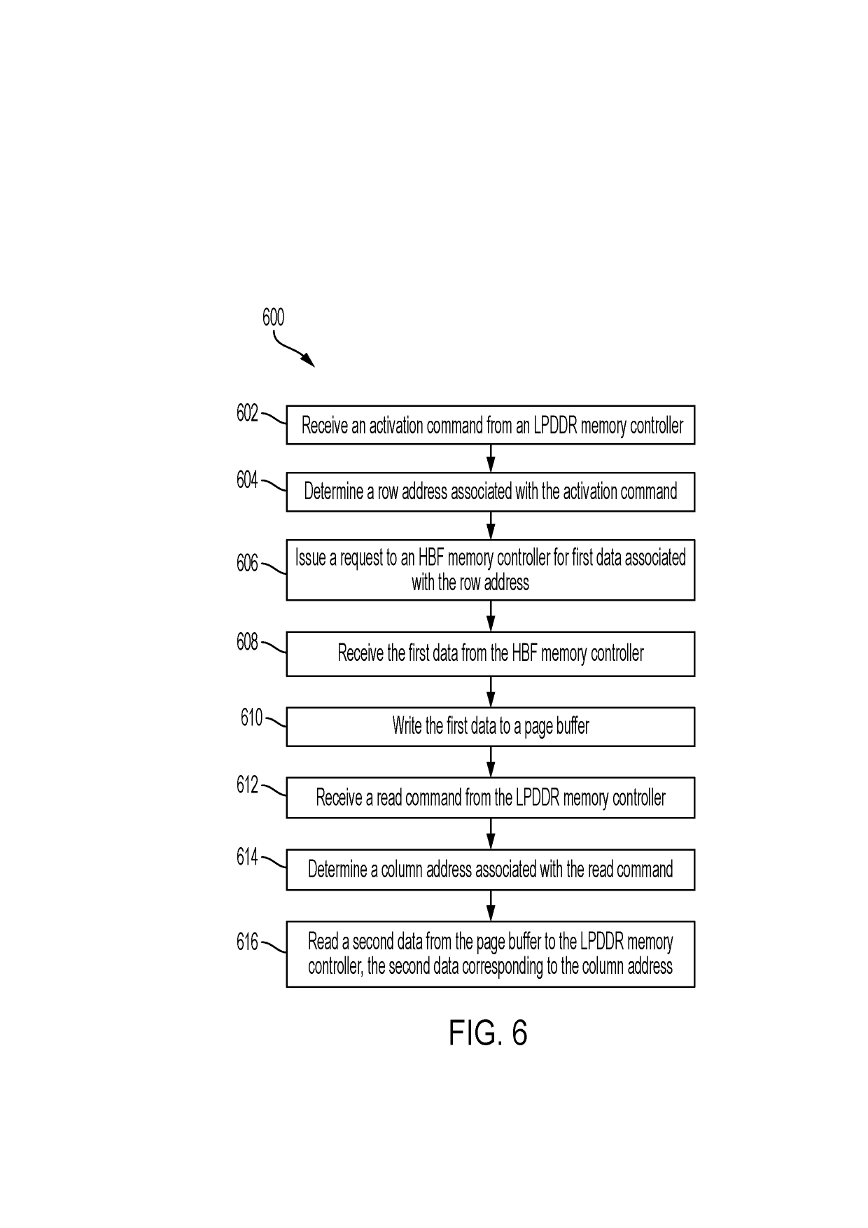

FIG. 6 is a diagram depicting a method 600 for reading data from a first memory controller (e.g., an HBF memory controller 204) to a second memory controller (e.g., an LPDDR memory controller 218), according to some embodiments of the present disclosure. Although FIG. 6 illustrates various operations in a method for interfacing with a host device 102, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure. Referring to FIG. 6, the method 600 may include one or more of the following operations.

At operation 602, a processing circuit of an LPDDR core 202 may receive an activation command from an LPDDR memory controller 218. For example, referring to FIG. 3, the activation command may be a command type of the command 312 received at the command decoder 208 of the LPDDR core 202.

At operation 604, the processing circuit of the LPDDR core 202 may determine a row address associated with the activation command. For example, referring to FIG. 3, the address register 302 of the LPDDR core 202 may receive an address signal 314 from the LPDDR memory controller 218 that includes the row address. The row decoder 214 may obtain the row address from the address register 302.

At operation 606, the processing circuit of the LPDDR core 202 may issue a request to an HBF memory controller 204 for first data associated with the row address. For example, referring to FIG. 3, the row decoder 214 may issue the request to the HBF memory controller 204 with the row address.

At operation 608, the processing circuit of the LPDDR core 202 may receive the first data from the HBF memory controller 204.

At operation 610, the processing circuit of the LPDDR core 202 may write the first data to a page buffer 310.

At operation 612, the processing circuit of the LPDDR core 202 may receive a read command from the LPDDR memory controller 218. For example, referring to FIG. 3, the read command may be a command type of the command 312 received at the command decoder 208 of the LPDDR core 202.

At operation 614, the processing circuit of the LPDDR core 202 may determine a column address associated with the read command. For example, referring to FIG. 3, the address register 302 of the LPDDR core 202 may receive an address signal 314 from the LPDDR memory controller 218 that includes the column address. The column decoder 216 may obtain the column address from the address register 302.

At operation 616, the processing circuit of the LPDDR core 202 may read a second data from the page buffer 310 to the LPDDR memory controller 218, the second data corresponding to the column address.

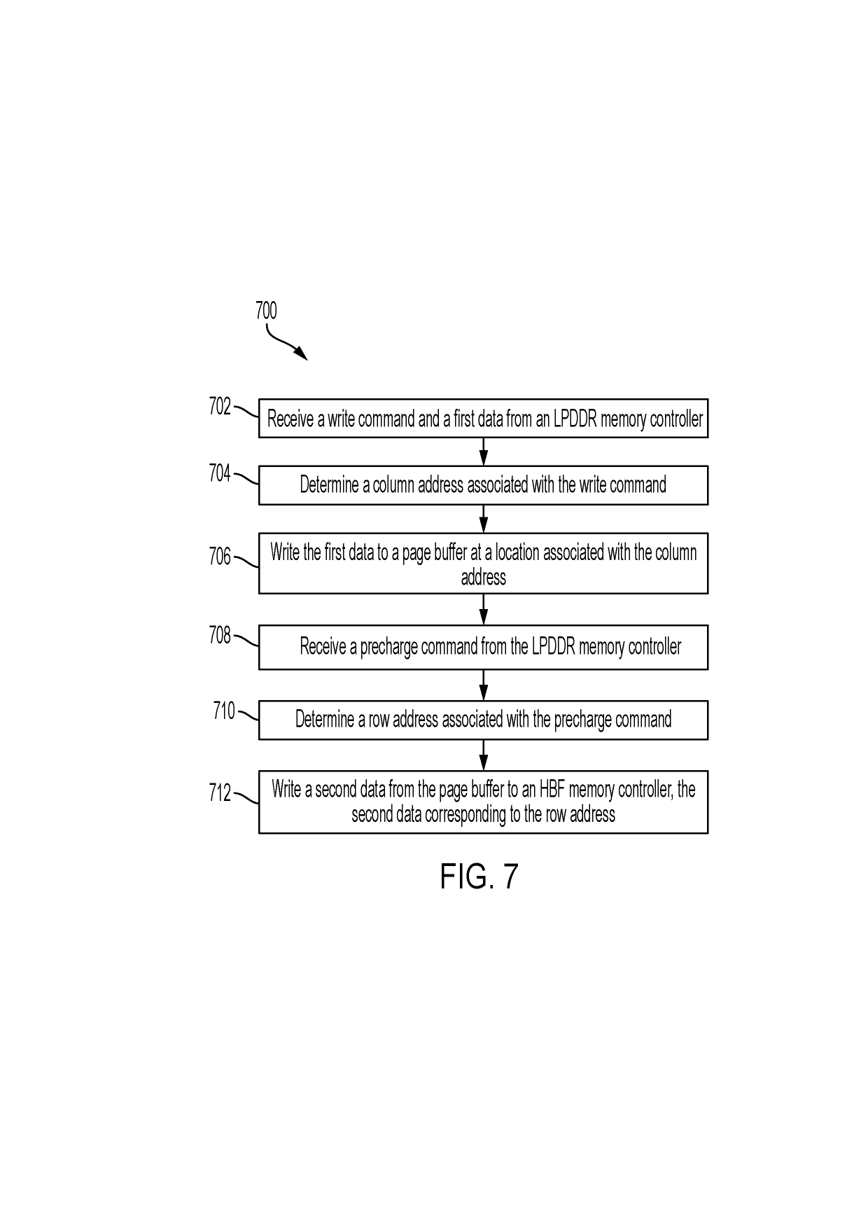

FIG. 7 is a diagram depicting a method 700 for writing data from the second memory controller (e.g., LPDDR memory controller 218) to the first memory controller (e.g., HBF memory controller 204), according to some embodiments of the present disclosure. Although FIG. 7 illustrates various operations in a method for interfacing with a host device 102, embodiments according to the present disclosure are not limited thereto, and according to some embodiments, the method may include additional operations, or fewer operations, or the order of operations may vary unless otherwise stated or implied, without departing from the spirit and scope of embodiments according to the present disclosure. Referring to FIG. 7, the method 700 may include one or more of the following operations.

At operation 702, a processing circuit of an LPDDR core 202 may receive a write command and a first data from an LPDDR memory controller 218. For example, referring to FIG. 3, the write command may be a command type of the command 312 received at the command decoder 208 of the LPDDR core 202.

At operation 704, the processing circuit of the LPDDR core 202 may determine a column address associated with the write command. For example, referring to FIG. 3, the address register 302 of the LPDDR core 202 may receive an address signal 314 from the LPDDR memory controller 218 that includes the column address. The column decoder 216 may obtain the column address from the address register 302.

At operation 706, the processing circuit of the LPDDR core 202 may write the first data to a page buffer 310 at a location associated with the column address.

At operation 708, the processing circuit of the LPDDR core 202 may receive a precharge command from the LPDDR memory controller 218. For example, referring to FIG. 3, the precharge command may be a command type of the command 312 received at the command decoder 208 of the LPDDR core 202.

At operation 710, the processing circuit of the LPDDR core 202 may determine a row address associated with the precharge command. For example, referring to FIG. 3, the address register 302 of the LPDDR core 202 may receive an address signal 314 from the LPDDR memory controller 218 that includes the row address. The row decoder 214 may obtain the row address from the address register 302.

At operation 712, the processing circuit of the LPDDR core 202 may write a second data from the page buffer 310 to an HBF memory controller 204, the second data corresponding to the row address.

Accordingly, aspects of some embodiments of the present disclosure provide for improvements to memory communications by allowing a controller associated with a memory type having a first latency (e.g. a lower latency) to be compatible with a controller associated with a memory type having a second latency (e.g., a higher latency). Aspects of some embodiments of the present disclosure may provide improvements to the performance of devices that utilize LPDDR memory protocol by enabling LPDDR memory controllers to read data from and write data to HBF NAND without the timing errors that might otherwise occur.

Example embodiments of the disclosure may extend to the following statements, without limitation:

Statement 1. An example method includes receiving, by a processing circuit, a first command associated with a first memory type, determining, by the processing circuit, a processing protocol for the first command, based on applying the processing protocol to the first command, generating, by the processing circuit, a second command for a memory controller associated with a second memory type different from the first memory type, sending, by the processing circuit, the second command to the memory controller, and performing, by the processing circuit, a task on a buffer of the processing circuit based on the processing protocol, wherein the buffer has a lower latency for performing the task than the second memory type.

Statement 2. An example method includes the method of statement 1, wherein the method further includes determining, by the processing circuit, a command type of the first command, wherein the processing protocol is determined based on the command type.

Statement 3. An example method includes the method of any of statements 1 and 2, wherein the command type is one of a row activation command, a row precharge command, a read command, or a write command.

Statement 4. An example method includes the method of any of statements 1-3, wherein the first memory type is a dynamic random-access memory (DRAM) memory type, and the second memory type is a high bandwidth flash (HBF) NAND memory type.

Statement 5. An example system for performing the method of any of statements 1-4, wherein the first command is associated with a low-power double data rate (LPDDR) controller, and the memory controller is a high bandwidth flash (HBF) controller.

Statement 6. An example system for performing the method of any of statements 1-5, wherein the first command is an activation command, and performing the task includes writing data received from the memory controller to the buffer.

Statement 7. An example system for performing the method of any of statements 1-6, wherein the first command is a precharge command, and performing the task includes sending data from the buffer to the memory controller.

Statement 8. An example system for performing the method of any of statements 1-7, wherein the first command is a write command, and performing the task includes writing data associated with the first command to the buffer.

Statement 9. An example system for performing the method of any of statements 1-8, wherein the first command is a read command, and performing the task includes reading data from the buffer and sending the data from the processing circuit via a host interface coupled to the processing circuit.

Statement 10. An example system includes a processing circuit, and a memory storing instructions, which, based on being executed by the processing circuit, cause the processing circuit to perform: receiving, by a processing circuit, a first command associated with a first memory type, determining, by the processing circuit, a processing protocol for the first command, based on applying the processing protocol to the first command, generating, by the processing circuit, a second command for a memory controller associated with a second memory type different from the first memory type, sending, by the processing circuit, the second command to the memory controller, and performing, by the processing circuit, a task on a buffer of the processing circuit based on the processing protocol, wherein the buffer has a lower latency for performing the task than the second memory type.

Statement 11. An example system includes the example system of statement 10, wherein the instructions, based on being executed by the processing circuit, further cause the processing circuit to perform: determining a command type of the first command, wherein the processing protocol is determined based on the command type.

Statement 12. An example system includes the example system of any of statements 10 and 11, wherein the command type is one of a row activation command, a row precharge command, a read command, or a write command.

Statement 13. An example system includes the example system of any of statements 10-12, wherein the first memory type is a dynamic random-access memory (DRAM) memory type, and the second memory type is a high bandwidth flash (HBF) NAND memory type.

Statement 14. An example system includes the example system of any of statements 10-13, wherein the first command is associated with a low-power double data rate (LPDDR) controller, and the memory controller is a high bandwidth flash (HBF) controller.

Statement 15. An example system includes the example system of any of statements 10-14, wherein the first command is an activation command, and performing the task includes writing data received from the memory controller to the buffer.

Statement 16. An example system includes the example system of any of statements 10-15, wherein the first command is a precharge command, and performing the task includes sending data from the buffer to the memory controller.

Statement 17. An example system includes the example system of any of statements 10-16, wherein the first command is a write command, and performing the task includes writing data associated with the first command to the buffer.

Statement 18. An example system includes the example system of any of statements 10-17, wherein the first command is a read command, and performing the task includes reading data from the buffer and sending the data from the processing circuit via a host interface coupled to the processing circuit.

Statement 19. An example system includes a processing circuit, and a memory storing instructions, which, based on being executed by the processing circuit, cause the processing circuit to perform: receiving a first command, determining a processing protocol for the first command, based on applying the processing protocol to the first command, generating a second command for the memory controller, the memory controller associated with a memory type, sending the second command to the memory controller, and performing a task on the buffer based on the processing protocol, wherein the buffer has a lower latency than the memory type.

Statement 20. An example system includes the example system of statement 19, wherein the memory type is a NAND memory type.

While embodiments of the present disclosure have been particularly shown and described with reference to the embodiments described herein, it will be understood by those of ordinary skill in the art that various changes in form and details may be made therein without departing from the spirit and scope of the present disclosure as set forth in the following claims and their equivalents.

What is claimed is:

1. A method comprising:
receiving, by a processing circuit, a first command associated with a first memory type;
determining, by the processing circuit, a processing protocol for the first command;
based on applying the processing protocol to the first command, generating, by the processing circuit, a second command for a memory controller associated with a second memory type different from the first memory type;
sending, by the processing circuit, the second command to the memory controller; and
performing, by the processing circuit, a task on a buffer of the processing circuit based on the processing protocol, wherein the buffer has a lower latency for performing the task than the second memory type.

2. The method of claim 1, further comprising:
determining, by the processing circuit, a command type of the first command, wherein the processing protocol is determined based on the command type.

3. The method of claim 2, wherein the command type is one of a row activation command, a row precharge command, a read command, or a write command.

4. The method of claim 1, wherein the first memory type is a dynamic random-access memory (DRAM) memory type, and the second memory type is a high bandwidth flash (HBF) NAND memory type.

5. The method of claim 1, wherein the first command is associated with a low-power double data rate (LPDDR) controller, and the memory controller is a high bandwidth flash (HBF) controller.

6. The method of claim 1, wherein:
the first command is an activation command; and
performing the task comprises writing data received from the memory controller to the buffer.

7. The method of claim 1, wherein:
the first command is a precharge command; and
performing the task comprises sending data from the buffer to the memory controller.

8. The method of claim 1, wherein:
the first command is a write command; and
performing the task comprises writing data associated with the first command to the buffer.

9. The method of claim 1, wherein:
the first command is a read command; and
performing the task comprises reading data from the buffer and sending the data from the processing circuit via a host interface coupled to the processing circuit.

10. A system comprising:
a processing circuit; and
a memory storing instructions, which, based on being executed by the processing circuit, cause the processing circuit to perform:
receiving a first command associated with a first memory type;
determining a processing protocol for the first command;
based on applying the processing protocol to the first command, generating a second command for a memory controller associated with a second memory type different from the first memory type;
sending the second command to the memory controller; and
performing a task on a buffer of the processing circuit based on the processing protocol, wherein the buffer has a lower latency for performing the task than the second memory type.

11. The system of claim 10, wherein the instructions, based on being executed by the processing circuit, further cause the processing circuit to perform:
determining a command type of the first command, wherein the processing protocol is determined based on the command type.

12. The system of claim 11, wherein the command type is one of a row activation command, a row precharge command, a read command, or a write command.

13. The system of claim 10, wherein the first memory type is a dynamic random-access memory (DRAM) memory type, and the second memory type is a high bandwidth flash (HBF) NAND memory type.

14. The system of claim 10, wherein the first command is associated with a low-power double data rate (LPDDR) controller, and the memory controller is a high bandwidth flash (HBF) controller.

15. The system of claim 10, wherein:
the first command is an activation command; and
performing the task comprises writing data received from the memory controller to the buffer.

16. The system of claim 10, wherein:
the first command is a precharge command; and
performing the task comprises sending data from the buffer to the memory controller.

17. The system of claim 10, wherein:
the first command is a write command; and
performing the task comprises writing data associated with the first command to the buffer.

18. The system of claim 10, wherein:
the first command is a read command; and
performing the task comprises reading data from the buffer and sending the data from the processing circuit via a host interface coupled to the processing circuit.

19. A system comprising:
a processing circuit comprising a buffer;
a memory controller; and
a memory storing instructions, which, based on being executed by the processing circuit, cause the processing circuit to perform:
receiving a first command;
determining a processing protocol for the first command;
based on applying the processing protocol to the first command, generating a second command for the memory controller, the memory controller associated with a memory type;
sending the second command to the memory controller; and
performing a task on the buffer based on the processing protocol, wherein the buffer has a lower latency for performing the task than the memory type.

20. The system of claim 19, wherein the memory type is a NAND memory type.
